(19) United States
(12) Patent Application Publication
(10) Pub. No.: US 2019/0193641 A1
(43) Pub. Date: Jun. 27, 2019

(54) Fisherman's Gear Box

(71) Applicants: Octavio I. Garza, JR., Cibolo, TX (US); Domingo Dominick Garza, Cibolo, TX (US)

(72) Inventors: Octavio I. Garza, JR., Cibolo, TX (US); Domingo Dominick Garza, Cibolo, TX (US)

(21) Appl. No.: 16/212,381

(22) Filed: Dec. 6, 2018

Related U.S. Application Data
(60) Provisional application No. 62/595,341, filed on Dec. 6, 2017.
(60) Provisional application No. 62/713,031, filed on Aug. 1, 2018.

(51) Int. Cl. B60R 9/08; A01K 97/08; A01K 97/06; B60R 9/06

(52) U.S. Cl. CPC B60R 9/08; B60R 9/065; A01K 97/06; A01K 97/08

(57) ABSTRACT

A fisherman's gear box is shown for attaching to the trailer hitch of a vehicle. Reels can be locked inside the box with the rods extending upward therefrom. Space can also be provided for fishing tackle inside of the locked fisherman's gear box.

### CROSS-REFERENCE TO RELATED APPLICATIONS

This invention claims priority back to Provisional Application for Patent No. 62/595,341, filed Dec. 6, 2017 and Provisional Application for Patent No. 62/713,031, filed Aug. 1, 2018.

### BACKGROUND OF THE INVENTION

### 1. Field of the Invention

The present invention relates to fishing and, more particularly, to a safe way to protect fishing gear from damage and/or theft.

### 2. Description of the Prior Art

Fishermen typically drive from where they reside to their favorite fishing hole. The trip may be a short distance or a long distance. The cost of the fishing gear is getting to be very expensive. A good rod and reel can easily cost one thousand dollars ($1,000.00) or more. A tackle box containing weights, lines, hooks, flies and assorted fishing gear, may have several thousand dollars' worth of fishing gear.

Most serious fishermen¹ have more than one rod or reel. A serious fisherman may take a half-dozen rods and reels when going on a fishing trip. 1 The term “Fisherman” is used generically to include both men and women, young or old.

If the fisherman stops for breakfast or a cup of coffee, the fishing gear remains in the vehicle, such as in the back of a pick-up truck. Many times, fishing gear has been stolen from unattended vehicles when in transit to or from the fishing location.

In the past, fishing rod and reel holders have been designed to be mounted on the back or front of a vehicle. However, these fishing rod and reel holders do not prevent someone from walking by and taking one or more of the rods and/or reels. If the tackle box is handy, it can also be taken.

Upon arriving at the fishing location, typically the fisherman will take some, but not all, of the fishing gear to their fishing spot. This leaves the vehicle that may contain the remainder of the fishing gear unattended. The unattended fishing gear can again be stolen if not secured.

Most fishermen drive a vehicle that has a trailer hitch, especially those that drive pick-up trucks. While devices have in the past been designed to fit on a trailer hitch to carry fishing equipment, none of these devices are lockable and capable of storing all of the fishing gear, including rods and reels and tackle boxes.

### SUMMARY OF THE INVENTION

An object of the present invention is a fisherman's gear box to prevent theft of fishing gear.

A further object of the present invention is to prevent fishing gear from being stolen while in transit to or from the fishing location.

It is still a further object of the present invention to prevent rods and reels from being stolen off the vehicle.

It is yet another object of the present invention to provide a locked container secured to a vehicle, which locked container will contain the fishing reels and tackle boxes with only a portion of the rod showing.

It is still a further object of the present invention to provide a fisherman's gear box that can be carried on the trailer hitch of a vehicle, which fisherman's gear box is lockable with only part of the rods extending there from.

It is a further object of the present invention to provide a fisherman's gear box which mounts on the trailer hitch of a vehicle, which fisherman's gear box has a compartment for the tackle box plus holders for the fishing rods and reels. The fisherman's gear box can be locked shut and locked on the trailer hitch to prevent theft there from.

It is a further object of the present invention to have a fisherman's gear box with vertical cylinders therein in which rods and reels can be located with a slot there above to allow the rods to extend through the slots in the top of the fisherman's gear box.

It is a further object of the present invention to have a fisherman's gear box that is totally lockable to keep the fishing gear contained therein from being stolen.

### DESCRIPTION OF THE DRAWINGS

FIG. 1 is a perspective view of a fisherman's gear box made in accordance with the present invention.

FIG. 2 is a top view of FIG. 1.

FIG. 3 is a front view of FIG. 1.

FIG. 4 is a top view of FIG. 1 with the lid on the fisherman's gear box being open.

FIG. 4A is a cross-sectional view of FIG. 4 along section lines 4A-4A.

FIG. 5 is a bottom perspective view of a fisherman's gear box.

FIG. 6 is a cross-sectional view of FIG. 4 taken along section lines 6-6.

FIG. 6A is a partial sectional view of the lock shown in FIG. 6.

FIG. 7 is a perspective environmental view of the present invention.

FIG. 8 is a perspective view of an alternative fisherman's gear box made in accordance with the present invention.

FIG. 9 is a top view of FIG. 8.

FIG. 10 is a front view of FIG. 8.

FIG. 11 is a top view of FIG. 8 with the lid of the fisherman's gear box being open.

FIG. 11a is a cross-sectional view of FIG. 11 along section lines 11-11a.

FIG. 12 is a partial sectional view.

FIG. 13 is a lower perspective view of the alternative fisherman's gear box made in accordance with the present invention.

FIG. 14 is a perspective environmental view of the alternative fisherman's gear box.

### DESCRIPTION OF THE PREFERRED EMBODIMENT

Referring to FIG. 7, a perspective view of the Fisherman's gear box 10 is shown attached to the trailer hitch 12 of a truck 14. The fisherman's gear box 10 has a rectangular box 16 with a lid 18. The lid 18 has slots 20 on the forward side thereof. Piano hinge 22 connects the lid 18 to the rectangular box 16. The rods 24 extend through slots 20 into the fisherman's gear box 10.

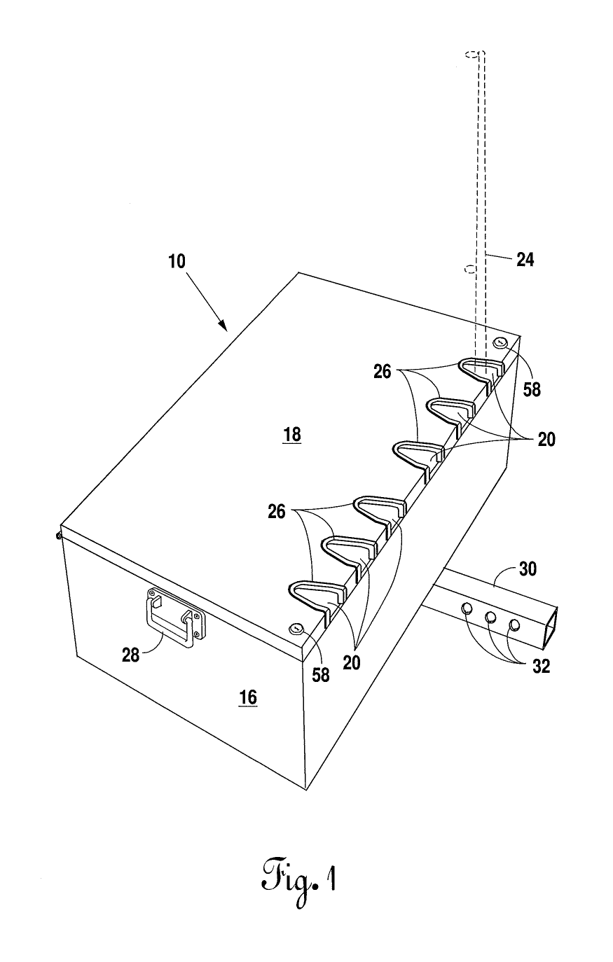

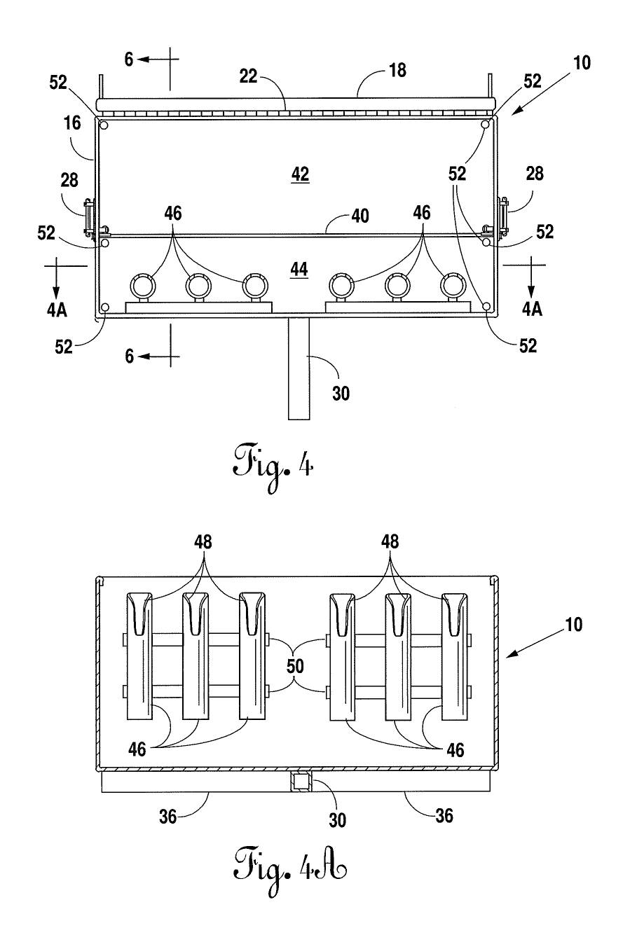

Referring now to FIGS. 1, 2 and 3 in combination, the fisherman's gear box 10 has lid 18 on the top of rectangular box 16. The slots 20 are formed in the forward part of lid 18. A rubber edge 26 prevents the sides of the slots 20 from damaging the fishing rods 24. The handles 28 mounted on either end of the rectangular box 16 provides a way for someone to pick up the entire fisherman's gear box 10.

Tongue 30 extends from under the fisherman's gear box 10 and is received in the trailer hitch 12 (see FIG. 7). Holes 32 can receive a locking pin (not shown) therein when received inside of the trailer hitch 12. The locking pin will prevent someone from taking the entire fisherman's gear box 10. Locking pins are sold under several names, such as a Trimax Universal Receiver Lock or a Reese Towpower Professional Towing Receiver, Model #7070700.

Referring to FIG. 5, the underside of the fisherman's gear box 10 is shown. The tongue 30 connects to cross-braces 34 and 36, which are welded to the bottom 38 of the fisherman's gear box 10. Cross-braces 34 and 36 ensure there is an adequate support under the bottom of the fisherman's gear box 10.

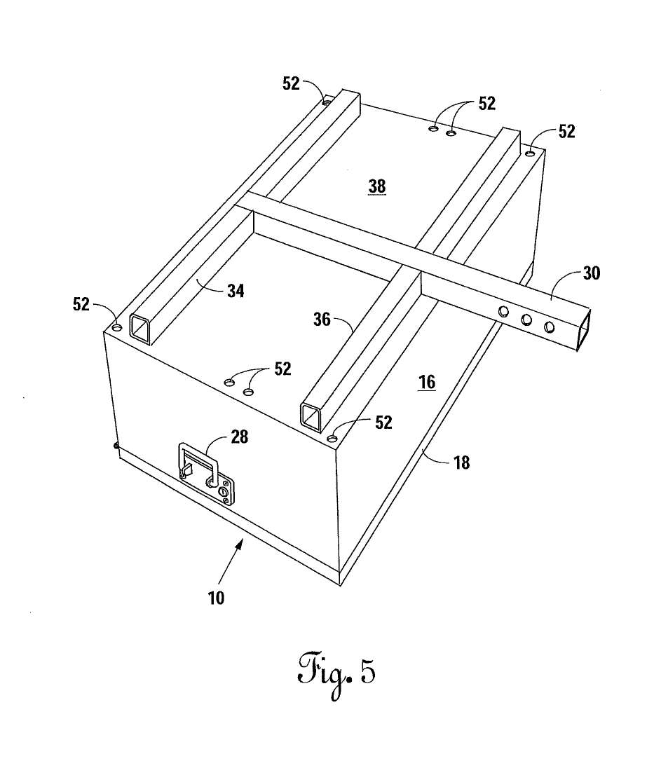

Referring to FIGS. 4 and 4A the inside of the fisherman's gear box 10 is shown. In FIG. 4, the lid 18 is open to show the inside of the rectangular box 16. The handles 28 are shown mounted on either end of the rectangular box 16.

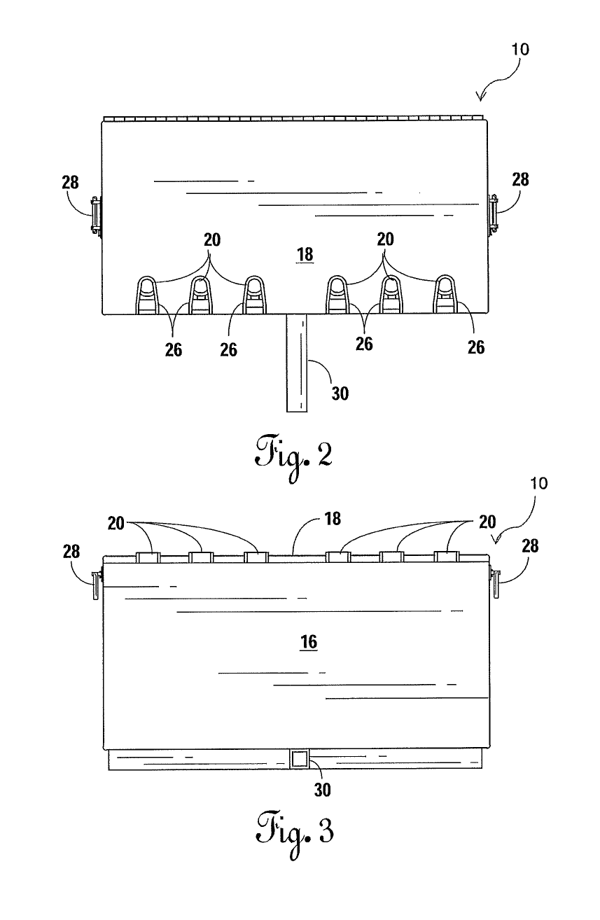

Contained inside of the rectangular box 16 is a dividing wall 40. Behind the dividing wall 40 is a compartment 42 in which the tackle box or other assorted fishing gear can be inserted. In the front of the dividing wall 40 is compartment 44 which has cylindrical rod holders 46 vertically mounted therein. The cylindrical rod holders 46 are located immediately below the slots 20 (see FIGS. 1 and 2). The cylindrical rod holders 46 have slots 48 to better receive some brands of fisherman's reels therein. Horizontal bars 50 provide additional support for mounting the cylindrical rod holders 46.

Drain holes 52 are provided in the bottom of the fisherman's gear box 10 as can be seen in FIGS. 4 and 5 to prevent any accumulation of water therein.

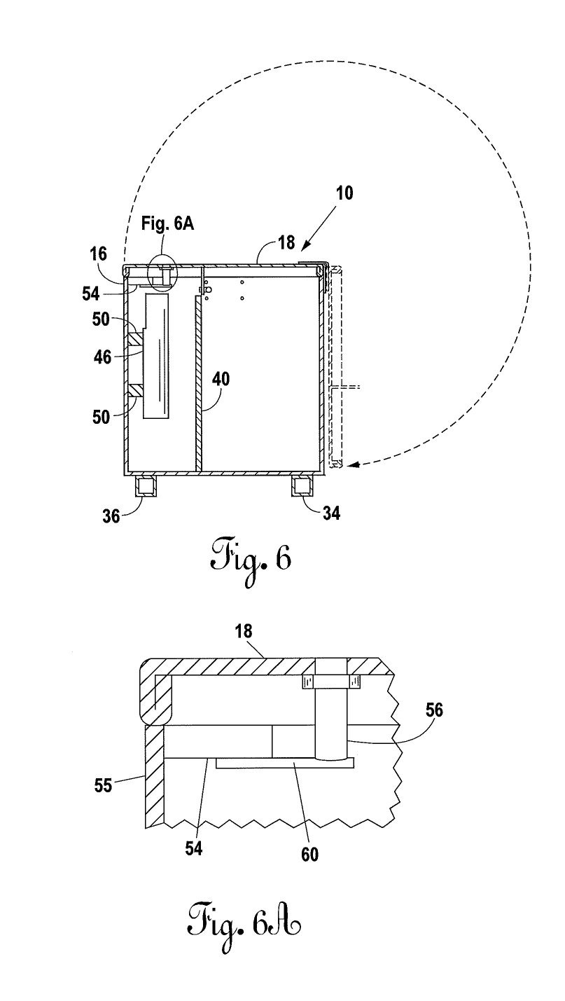

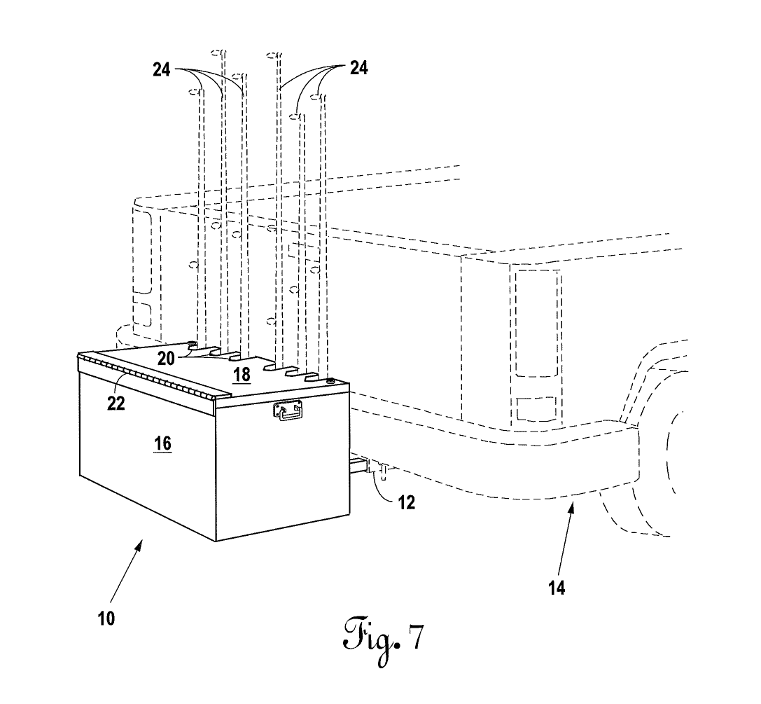

Referring to FIG. 6, which is a cross-sectional view of FIG. 4 along section lines 6-6, the inside of the fisherman's gear box 10 can be better shown. The lid 18 on the rectangular box 16 can swing all the way open as illustrated in FIG. 6. The dividing wall 40 extends up from the bottom of the rectangular box to almost the lid 18. Mounting of the cylindrical rod holders 46 on the horizontal bars 50 is illustrated. The cross-braces 34 and 36 below the rectangular box 16 are shown.

Referring to FIG. 6A, which is an enlarged partial sectional view of FIG. 6 at section lines 6A, a locking bar 54 is attached to side 55. Extending through the lid 18 of the rectangular box 16 is a locking cylinder 56. By inserting a key (not shown) into the keyhole 58 of the locking cylinder 56, (see FIG. 1), the locking cylinder 56 may be turned. The turning of the locking cylinder 56 turns the rotating bar 60 which is rotated under locking bar 54. The turning of the rotating bar 60 under the locking bar 54 will lock the lid 18 shut so that someone cannot get inside of the fisherman's gear box 10 to steal any of the fishing gear.

Referring now to FIG. 14, there is shown an alternative fisherman's gear box 64. The alternative fisherman's gear box 64 has a rectangular box 66 mounted on a bar support 66 that connects into a trailer hitch 70.

The fisherman's gear box 64 has a lid 72 on top of the rectangular box 66. The lid 72 is connected to the rectangular box 66 by piano hinge 74. On each end of the rectangular box 66 are handles 76.

Extending up through slots 78 and lid 72 are rods 80. The fisherman's gear box 64 as shown in FIG. 14 is narrower than the fisherman's gear box 10 as shown in FIG. 7.

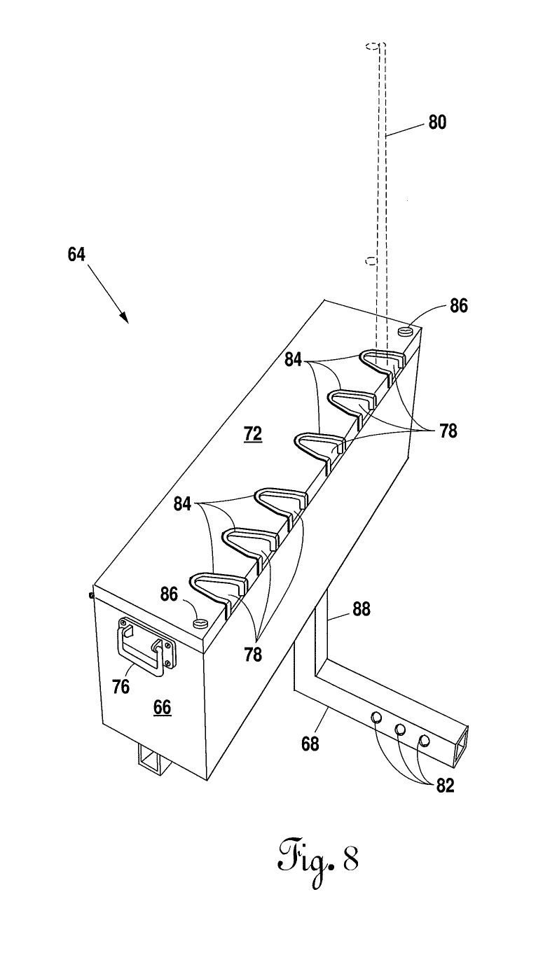

Referring to FIG. 8, a perspective view of the fisherman's gear box 64 is shown. The bar support 68 has holes 82 therein to receive a locking pin for the trailer hitch 70. The rod 80 extends out of one of the slots 78 in an upward direction. Edges of the slot 78 are covered with rubber 84 to prevent damage to the rods. The lid 72 is held closed by locks 86 in a manner as will be described subsequently.

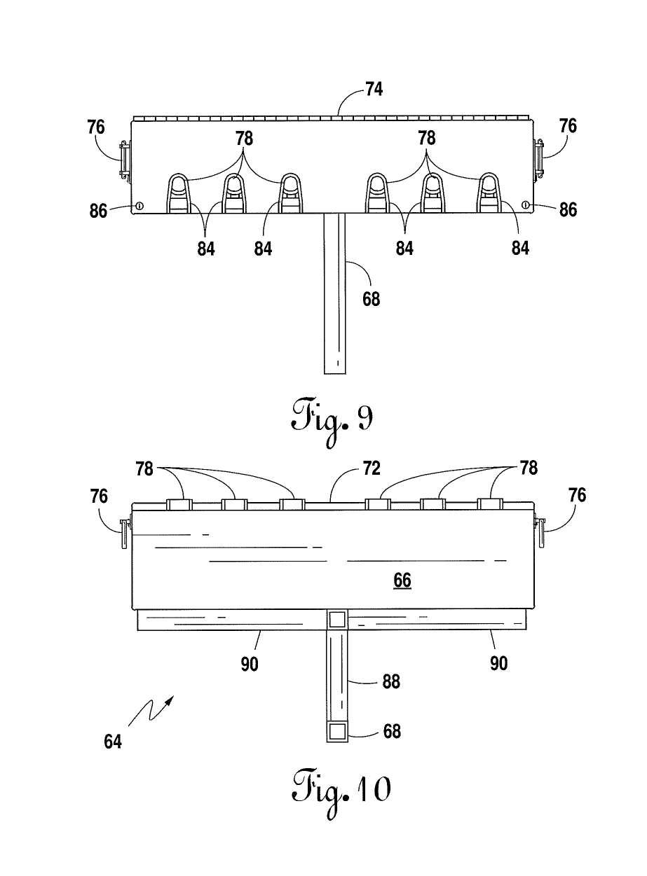

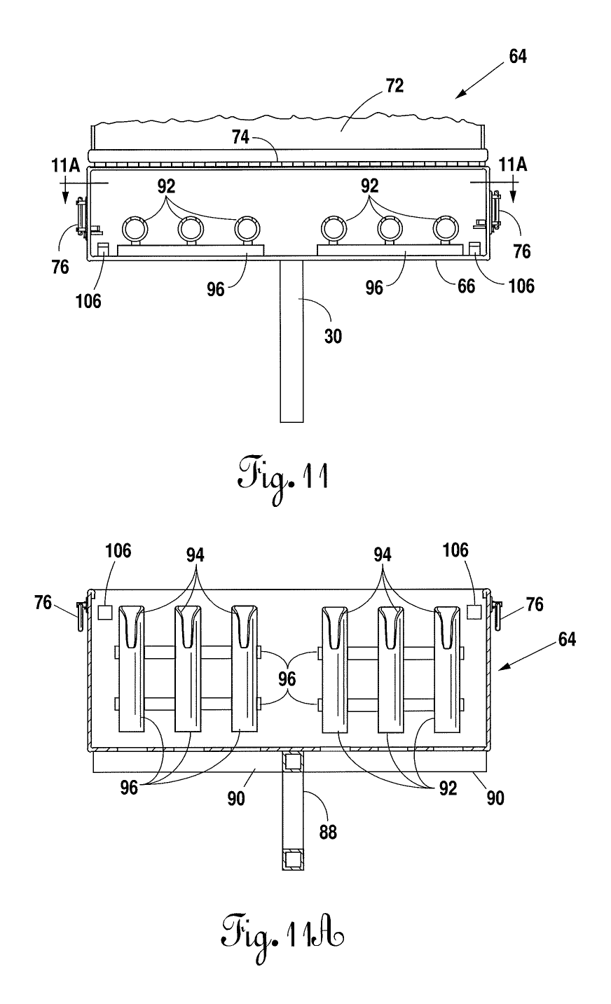

FIG. 9 is a top view of FIG. 8. FIG. 10 is a front view of FIG. 8. To raise the fisherman's gear box 64 higher behind the truck 14, bar support 68 has a raised section 88. The top of the raised section 88 is connected to a horizontal support bar 90.

Referring now to FIGS. 11 and 11a, the inside of the fisherman's gear box 64 is shown. The same numbers as applied to FIGS. 8 through 10 apply to FIGS. 11 and 11a. In FIG. 11, which is a top view of the fisherman's gear box 64, the lid 72 is open. Inside of the fisherman's gear box 64 towards the front thereof are cylindrical rod holders 92. The cylindrical rod holders 92 have slots 94 cut in the top thereof so that the rod and reel will slide into place. Horizontal bars 96 provide additional support for the cylindrical rod holders 92.

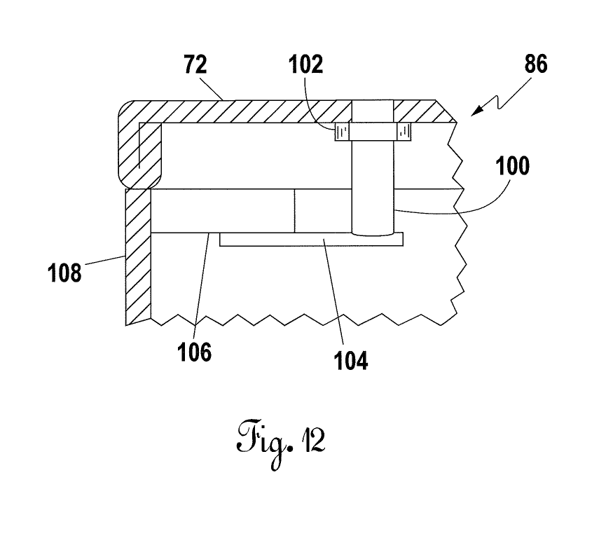

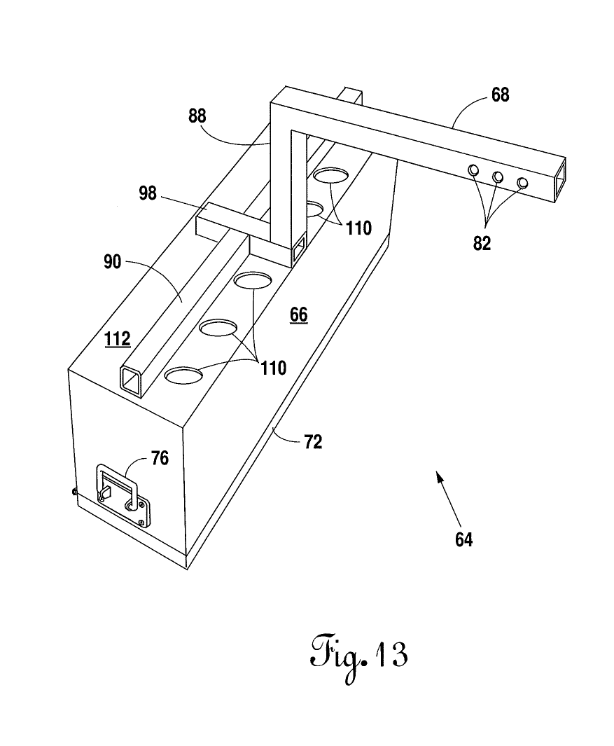

Referring to FIG. 12, the lock 86 is shown in further detail. A locking cylinder 100 is held in place by nut 102 on the underside of lid 72. By the turning of the locking cylinder 100, locking tab 104 extends under locking bar 106 that is attached to side 108. Locks 86 are located in each corner of the fisherman's gear box 64 as shown in FIG. 8. The locking bar 106 is also shown in FIGS. 11 and 11A.

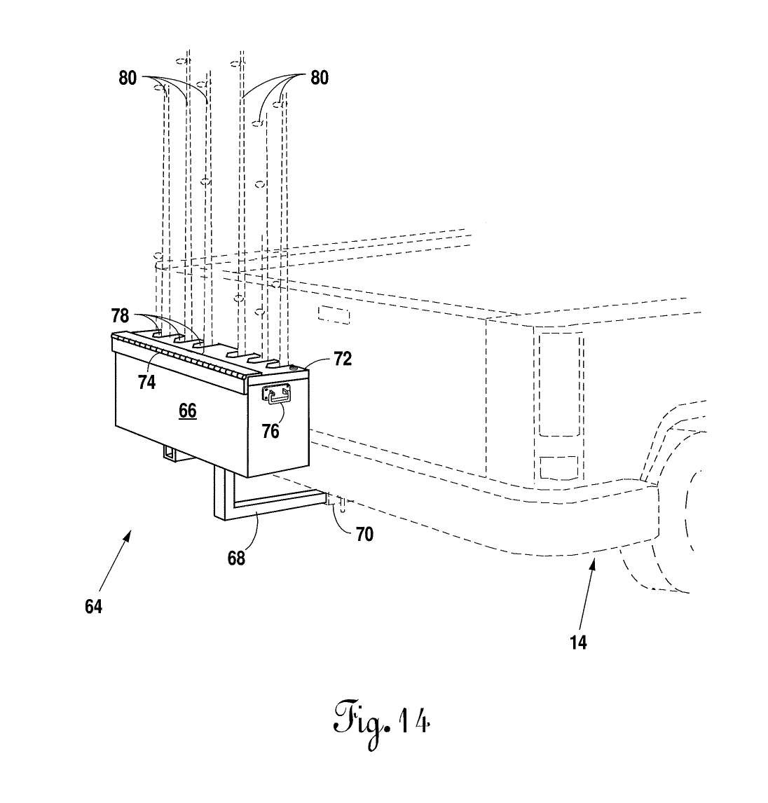

A bottom view of the fisherman's gear box 64 is shown in FIG. 13. The bar support 68, which has the holes 82 therein to be received in the trailer hitch 70 (see FIG. 14) connects to the raised section 88. The raised section 88 in turn connects to a rearward bar 98, which in turn connects to the horizontal support bars 90. This provides sufficient support for the fisherman's gear box. Holes 110 are provided in the bottom 112 of the rectangular box 66 so that any water that may be therein can drain out.

In the fisherman's gear box 64 that is shown as an alternative, space for the fishing tackle is not provided. In this alternative, fisherman's gear box 64 is anticipated that a separate tackle box will be used by the fisherman.

We claim:

1. A fisherman's gear box for storing and transporting rods, reels, weights, lines, hooks, flies and assorted fishing gear in a trailer hitch of a vehicle during a fishing trip, the fisherman's gear box comprises:
a rectangular box having a lid on top;
a tongue with cross braces on a first end thereof supporting and attached to an underside of said rectangular box, a second end of said tongue fitting into said trailer hitch;
rod slots in a front of said lid to receive said rods in said rod slots, a rear of said id being hinged to a top of said rectangular box;
cylindrical rod holders being vertically attached to an inside front of said rectangular box and located below said rod slots in said lid when said lid is closed;
reel slots in an upper end of said cylindrical rod holders and facing away from said inside front of said rectangular box, space between said reel slots and an underside of said lid being sufficient for said reels;
handles on each end of said rectangular box for loading or unloading;
a lock for locking said lid when closed on said rectangular box; and
a locking pin for extending through said second end of said tongue and said trailer hitch on locking said fisherman's tool box to said vehicle.

2. The fisherman's gear box as recited in claim 1, wherein said rod slots are lined with rubber edging to protect said rods.

3. The fisherman's gear box as recited in claim 2 further includes horizontal bars on said inside front of said rectangular box to which said cylindrical rod holders are vertically attached.

4. The fisherman's gear box as recited in claim 3, wherein said lock has an opening in said lid with a locking cylinder being mounted therein and extending downward, a rotating bar attached to a lower end of said locking cylinder, said rotating bar being rotated under a locking bar secured to an upper inside of said rectangular box.

5. The fisherman's gear box as recited in claim 4 further includes a rearward extension of said rectangular box and said lid, a vertical dividing wall separating said rearward extension from other areas inside of said rectangular box, said weights, lines, hooks, flies and assorted fishing gear being stored in said rearward extension.

6. The fisherman's gear box as recited in claim 5 further includes drain holes in said underside of said rectangular box.

7. The fisherman's gear box as recited in claim 6, where there are two of said locks, one on each end of said lid.

8. The fisherman's gear box as recited in claim 7, wherein said lid is hinged to a rear top edge of said rectangular box with a piano hinge.
